(19) United States
(12) Patent Application Publication
(10) Pub. No.: US 2026/0015007 A1
(43) Pub. Date: Jan. 15, 2026

(54) DRIVE RECORDER AND CONTROL METHOD THEREOF

(71) Applicant: HONDA MOTOR CO., LTD., Tokyo (JP)

(72) Inventors: Ryuji IWASHITA, Wako-shi (JP); Srinivasa Divakar BHAT, Wako-shi (JP); Prateek GARG, Wako-shi (JP); Akira KANEHARA, Wako-shi (JP); Masamitsu TSUCHIYA, Wako-shi (JP); Mudit SONI, Wako-shi (JP); Tarun SATHESH, Wako-shi (JP); Surbhi AGRAWAL, Wako-shi (JP)

(21) Appl. No.: 19/338,415

(22) Filed: Sep. 24, 2025

Related U.S. Application Data
(63) Continuation of application No. PCT/JP2023/013626, filed on Mar. 31, 2023.

(51) Int. Cl. B60W 50/14; G06V 20/56; G08G 1/16

(52) U.S. Cl. CPC B60W 50/14; G06V 20/588; G08G 1/167

(57) ABSTRACT

A drive recorder includes a camera configured to generate an image ahead of a vehicle to which the drive recorder is attached, an identification unit configured to identify, based on the image, a lane marking of a road on which the vehicle is traveling, a determination unit configured to determine whether the vehicle is likely to depart from a travel lane, based on a change amount per unit time in a distance between the drive recorder and the lane marking, and a warning unit configured to output a warning upon determination that the vehicle is likely to depart from the travel lane.

### CROSS-REFERENCE TO RELATED APPLICATION(S)

This application is a continuation of International Patent Application No. PCT/JP2023/013626 filed on Mar. 31, 2023, the entire disclosure of which is incorporated herein by reference.

### BACKGROUND OF THE INVENTION

### Field of the Invention

The present invention relates to a drive recorder and a control method thereof.

### Description of the Related Art

A technique for warning a driver that a vehicle is likely to depart from a lane is known. Such a warning is called a lane departure warning. In the technique described in Japanese Patent Laid-Open No. 2018-43539, whether the vehicle will depart from the travel lane is determined, based on a reference line created in accordance with the state of the lane and an estimated location of the vehicle after a predetermined time. Instead of or in addition to the lane departure warning issued by the vehicle, it is conceivable that a lane departure warning is issued using a drive recorder. The installation position of the drive recorder may vary depending on the vehicle. Hence, it is difficult to identify the positional relationship between the vehicle and the lane and issue the lane departure warning only from an image generated by the drive recorder.

### SUMMARY OF THE INVENTION

According to some aspects of the present invention, the technique for issuing a vehicle departure warning using an image generated by a drive recorder is provided. According to some embodiments, a drive recorder comprising: a camera configured to generate an image ahead of a vehicle to which the drive recorder is attached; an identification unit configured to identify, based on the image, a lane marking of a road on which the vehicle is traveling; a determination unit configured to determine whether the vehicle is likely to depart from a travel lane, based on a change amount per unit time in a distance between the drive recorder and the lane marking; and a warning unit configured to output a warning upon determination that the vehicle is likely to depart from the travel lane is provided.

Further features of the present invention will become apparent from the following description of exemplary embodiments with reference to the attached drawings.

### BRIEF DESCRIPTION OF THE DRAWINGS

FIG. 1 is a block diagram illustrating a configuration example of a vehicle according to some embodiments.

FIG. 2 is a block diagram illustrating a hardware configuration example of a drive recorder according to some embodiments.

FIG. 3 is a flowchart for describing an operation example of the drive recorder according to some embodiments.

FIG. 4 is a schematic view illustrating an example of an image generated by the drive recorder according to some embodiments.

FIG. 5 is a schematic view illustrating an example of a warning condition according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

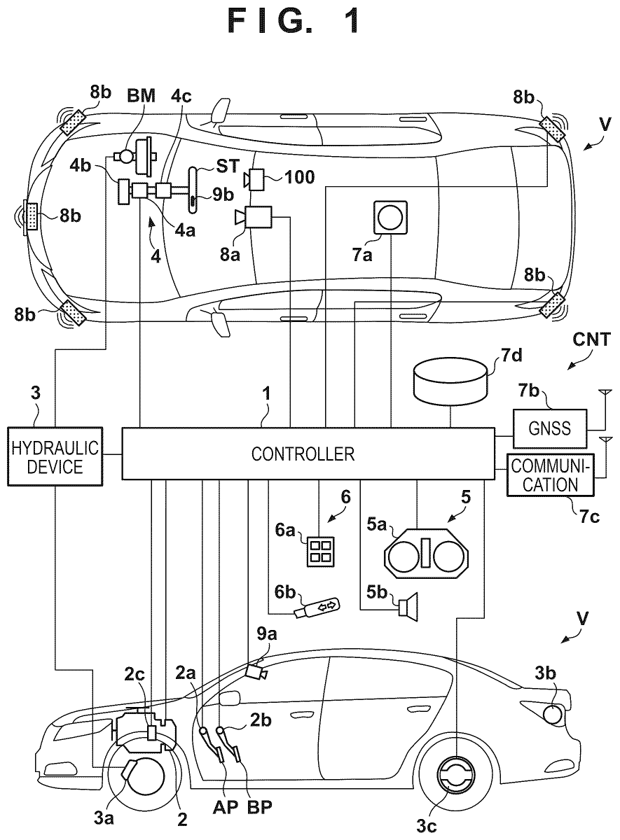

Referring to FIG. 1, a configuration example of a vehicle V according to some embodiments will be described. FIG. 1 is a block diagram of a control device CNT, and is a schematic diagram of a vehicle V as its application example. In FIG. 1, an outline of the vehicle V is illustrated in a plan view and a side view. The vehicle V in the present embodiment is, as an example, a sedan-type four-wheeled passenger vehicle, and can be, for example, a parallel hybrid vehicle. The vehicle V is not limited to the four-wheeled passenger vehicle, and may be a straddle type vehicle (a two-wheeled or three-wheeled motorcycle) or a large-sized vehicle such as a truck or a bus.

The control device CNT includes a controller 1, which is an electronic circuit that conducts control of the vehicle V including driving assistance of the vehicle V The controller 1 includes a plurality of electronic control units (ECUs). For example, an ECU is provided for every function of the control device CNT. Each ECU includes a processor represented by a central processing unit (CPU), a storage device such as a semiconductor memory, an interface with an external device, and the like. The storage device stores a program to be executed by the processor, data used for processing on the processor, and the like. The interface includes an input and output interface, and a communication interface. Each ECU may include a plurality of processors, a plurality of storage devices, and a plurality of interfaces. A program to be stored in the storage device may be installed in the control device CNT using a storage medium such as a CD-ROM so as to be stored in the storage device. Additionally or alternatively, the program to be stored in the storage device may be downloaded from an external server on wireless communication.

The controller 1 controls driving (acceleration) of the vehicle V by controlling a power unit (power plant) 2. The power unit 2 is a travelling drive unit that outputs driving force for rotating driving wheels of the vehicle V, and can include an internal combustion engine, a motor, and an automatic transmission. The motor can be used as a drive source for accelerating the vehicle V, and can also be used as a generator at the time of deceleration or the like (regenerative braking).

In the present embodiment, the controller 1 controls outputs of the internal combustion engine and the motor, or switches a gear ratio of the automatic transmission in accordance with a driver's driving operation detected by an operation detection sensor 2a provided in an accelerator pedal AP and an operation detection sensor 2b provided in a brake pedal BP, a vehicle speed of the vehicle V detected by a rotation speed sensor 2c, and the like. The automatic transmission is provided with the rotation speed sensor 2c, which detects the rotation speed of an output shaft of the automatic transmission, as a sensor for detecting a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A driver's braking operation on the brake pedal BP is converted into hydraulic pressure in a brake master cylinder BM, and is transmitted to the hydraulic device 3. The hydraulic device 3 is an actuator capable of controlling a hydraulic pressure of a hydraulic oil supplied to a brake device 3a (for example, a disc brake device) provided on each of the four wheels, based on the hydraulic pressure transmitted from the brake master cylinder BM.

The controller 1 is capable of controlling the braking of the vehicle V, by controlling the driving of an electromagnetic valve or the like included in the hydraulic device 3. In addition, the controller 1 is also capable of configuring an electric servo brake system, by controlling the distribution of the braking force by the brake device 3a and the braking force by the regenerative braking of the motor included in the power unit 2. The controller 1 may turn on a brake lamp 3b at the time of braking.

The controller 1 controls the steering of the vehicle V by controlling an electric power steering device 4. The electric power steering device 4 includes a mechanism for steering front wheels in response to a driver's driving operation (steering operation) on a steering wheel ST. The electric power steering device 4 includes a drive unit 4a, which exerts driving force (referred to as steering assist torque, in some cases) for assisting in the steering operation or automatic steering of the front wheels of the vehicle V The drive unit 4a includes a motor as a drive source. In addition, the electric power steering device 4 further includes a steering angle sensor 4b, which detects a steering angle, and a torque sensor 4c, which detects steering torque (also, referred to as steering load torque to be distinguished from steering assist torque) applied to the driver.

The controller 1 controls an electric parking brake device 3c provided in each of the rear wheels of the vehicle V. The electric parking brake device 3c includes a mechanism for locking the rear wheels. The controller 1 is capable of controlling locking and unlocking of the rear wheels by the electric parking brake device 3c.

The controller 1 controls an information output device 5, which notifies the inside of the vehicle of information. The information output device 5 includes, for example, a display device 5a, which notifies the driver of information by images, and/or a sound output device 5b, which notifies the driver of information by sound. Examples of the display device 5a include a display device provided in an instrument panel, and a display device provided in the steering wheel ST. In addition, the display device 5a may include a head-up display. The information output device 5 may notify an occupant of information using vibration or light.

The controller 1 receives an instruction input from the occupant (for example, the driver) via an input device 6. The input device 6 is disposed at a position in which the driver is able to operate, and includes, for example, a switch group 6a for the driver to give an instruction to the vehicle V, and/or a blinker lever 6b to activate a direction indicator (blinker).

The controller 1 recognizes and determines a current location and a course (an attitude) of the vehicle V. In the present embodiment, the vehicle V includes a gyro sensor 7a, a global navigation satellite system (GNSS) sensor 7b, and a communication device 7c. The gyro sensor 7a detects a rotational motion (yaw rate) of the vehicle V. The GNSS sensor 7b detects the current location of the vehicle V. In addition, the communication device 7c performs wireless communication with a server that provides map information and traffic information, and acquires these pieces of information. In the present embodiment, the controller 1 determines the course of the vehicle V, based on detection results of the gyro sensor 7a and the GNSS sensor 7b, also sequentially acquires map information about the course from the server via the communication device 7c, and stores the map information in a database 7d (a storage device). The vehicle V may also include another sensor for detecting a state of the vehicle V, such as an acceleration sensor for detecting acceleration of the vehicle V.

The controller 1 performs the driving assistance of the vehicle V, based on detection results of various detection units provided in the vehicle V. The vehicle V includes a plurality of surroundings detection units 8a and 8b, each of which is an external sensor for detecting the outside (a surrounding situation) of the vehicle V, and a plurality of in-vehicle detection units 9a and 9b, each of which is an in-vehicle sensor for detecting a state inside the vehicle (the states of occupants, particularly, the driver). The controller 1 is capable of grasping the surrounding situations of the vehicle V, based on the detection results of the surroundings detection units 8a and 8b, and then performing the driving assistance of the vehicle V in accordance with the surrounding situations. In addition, the controller 1 is capable of determining whether the driver is performing a predetermined operation that is an obligation of the driver imposed when performing the driving assistance, based on the detection results of the in-vehicle detection units 9a to 9b.

The surroundings detection unit 8a is an imaging device (hereinafter, referred to as a front camera 8a, in some cases) that captures an image ahead of the vehicle V, and is attached to a vehicle interior of the windshield at a front part of the roof of the vehicle V, for example. The imaging device captures an image of a subject to generate an image of such a subject. The controller 1 analyzes the image that has been captured by the front camera 8a, and is capable of extracting a contour of a target object or a lane marking (such as a white line) of a lane on a road.

The surroundings detection unit 8b is a millimeter wave radar (hereinafter, referred to as a radar 8b, in some cases), detects a target object in the surroundings of the vehicle V using radio waves, and detects (measures) a distance to the target object and a direction (azimuth) of the target object with respect to the vehicle V. In the example illustrated in FIG. 1, five radars 8b are provided, one at the center of the front portion of the vehicle V, one at each of the left and right corner portions of the front portion, and one at each of the left and right corner portions of the rear portion.

The surroundings detection units provided in the vehicle V are not limited to the above configuration. The number of cameras and the number of radars may be changed. A light detection and ranging (LiDAR) for detecting a target object in the surroundings of the vehicle V may be provided.

The in-vehicle detection unit 9a is an imaging device (hereinafter, referred to as an in-vehicle camera 9a, in some cases) that captures an image of the inside of the vehicle, and is attached to the vehicle interior at the front part of the roof of the vehicle V, for example. In the present embodiment, the in-vehicle camera 9a is a driver monitor camera that captures an image of the driver (for example, driver's eye and face). The controller 1 analyzes the image (the image of the driver's face) that has been captured by the in-vehicle camera 9a, and is capable of determining a driver's line of sight and a direction of a driver's face.

The in-vehicle detection unit 9b is a grip sensor (hereinafter, referred to as a grip sensor 9b, in some cases) for detecting the driver gripping the steering wheel ST, and is provided on, for example, at least a part of the steering wheel ST. As the in-vehicle detection unit, a torque sensor 4c, which detects the steering torque of the driver, may be used.

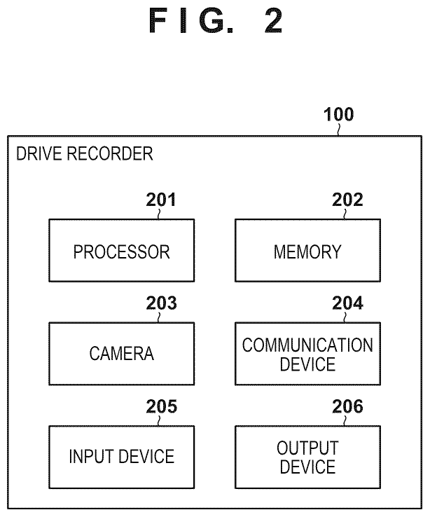

A drive recorder 100 is attached to the vehicle V. The drive recorder 100 records an image ahead of the vehicle V generated by a camera 203 (FIG. 2) of the drive recorder 100. The drive recorder 100 is attached to, for example, the vehicle interior of the windshield at the front part of the roof of the vehicle V. The installation position (in particular, a position in the vehicle width direction) of the drive recorder 100 may vary depending on the type of the vehicle V or the user's preference. In some embodiments, the drive recorder 100 analyzes the image ahead of the vehicle V, detects that the vehicle V is likely to depart from the travel lane, and outputs a warning to the user of the drive recorder 100. The travel lane may be a lane on which the vehicle is traveling. The user of the drive recorder 100 may be, for example, an occupant of the vehicle V, and in particular, may be the driver of the vehicle V. In the following description, the user of the drive recorder 100 will be simply referred to as the user. The warning that the vehicle V is likely to depart from the travel lane can also be referred to as a lane departure warning.

Examples of the driving assistance of the vehicle V provided for the driver include acceleration or deceleration assistance, lane keeping assistance, and lane changing assistance. The acceleration or deceleration assistance corresponds to driving assistance (adaptive cruise control (ACC)) in which the controller 1 automatically controls acceleration or deceleration of the vehicle V within a predetermined speed range by automatically controlling both the power unit 2 and the hydraulic device 3, based on the detection results of the surroundings detection units 8a and 8b and the map information. In the ACC, when there is a preceding vehicle, the acceleration or deceleration of the vehicle V is enabled so as to maintain an inter-vehicle distance from the preceding vehicle. The ACC reduces an operation load of the driver in the acceleration or deceleration operation (the operation on an accelerator pedal AP or a brake pedal BP).

The lane keeping assistance corresponds to driving assistance (lane keeping assist system (LKAS)) in which the controller 1 automatically controls the electric power steering device 4, based on the detection results of the surroundings detection units 8a and 8b and the map information so that the vehicle V keeps traveling within the lane. The LKAS reduces an operation load of the driver in a steering operation (an operation on the steering wheel ST) while the vehicle V is advancing straight.

The lane change assistance corresponds to driving assistance (auto lane changing (ALC) or active lane change assist (ALCA)) in which the controller 1 automatically controls the power unit 2, the hydraulic device 3, and the electric power steering device 4, based on the detection results of the surroundings detection units 8a and 8b and the map information to change the travel lane of the vehicle V to an adjacent lane. The ALC corresponds to the lane changing assistance based on a system request, whereas ALCA corresponds to the lane changing assistance based on a passenger's request. Examples of the system request include a case where a navigation system of giving a route guidance of the vehicle V to a destination requests a lane change of the vehicle V, and a case where the vehicle overtakes a preceding vehicle regardless of presence or absence of the route guidance. When making an occupant's request, the driver operates the input device (for example, the blinker lever 6b), and gives an instruction to change lanes. Both the ALC and the ALCA reduce an operation load of the driver in the acceleration or deceleration operation and the steering operation on the vehicle V, when changing lanes.

Other examples of the driving assistance control may include collision reduction braking that assists collision avoidance with a target object (for example, a pedestrian, another vehicle, or an obstacle) on a road, by controlling the hydraulic device 3, an ABS function, traction control, and/or attitude control of the vehicle V.

A hardware configuration example of the drive recorder 100 will be described with reference to FIG. 2. The drive recorder 100 may include, for example, the components illustrated in FIG. 2. The drive recorder 100 may not necessarily include some of the components illustrated in FIG. 2, or may include any component that is not included in FIG. 2. For example, the drive recorder 100 may further include a global navigation satellite system (GNSS) sensor, or an accelerometer.

A processor 201 controls the overall operation of the drive recorder 100. The processor 201 may be configured with, for example, a central processing unit (CPU). The processor 201 may be a single processor or a group of a plurality of processors.

A memory 202 stores programs and data for use in the operation of the drive recorder 100. The memory 202 may record an image (in particular, a moving image) ahead of the vehicle V generated by the camera 203. The memory 202 may be configured with, for example, a read-only memory (ROM) or a random access memory (RAM). The memory 202 may be a single memory or a group of a plurality of memories.

The camera 203 is a device for capturing an image ahead of the vehicle V. When the camera 203 captures an image ahead of the vehicle V, the image ahead of the vehicle V is generated. The drive recorder 100 is attached to the vehicle V so that the imaging range of the camera 203 is ahead of the vehicle V. The drive recorder 100 may further include a camera for capturing an image of a rearward side of the vehicle V.

A communication device 204 is a device that performs communication with a device different from the drive recorder 100. For example, the communication device 204 may be capable of communicating with the communication device 7c of the vehicle V. Alternatively or additionally, the communication device 204 may be capable of communicating with a portable device (for example, a smartphone) carried by the user. The communication by the communication device 204 may be wireless communication or wired communication. For example, the communication by the communication device 204 may be short-range wireless communication such as Bluetooth (registered trademark).

An input device 205 is a device for receiving an instruction from the user of the drive recorder 100. The input device 205 may be configured with a physical button, a toggle switch, a touch panel, or any combination of them. The instruction from the user to the drive recorder 100 may be acquired from another device via the communication device 204, in addition to or instead of the instruction via the input device 205.

An output device 206 is a device for outputting information to the user. The output device 206 may be configured with a display device such as a liquid crystal display, an acoustic device such as a speaker, a lamp, an indicator, or any combination of them. The output of the information to the user may be performed in another device via the communication device 204, in addition to or instead of the output via the output device 206.

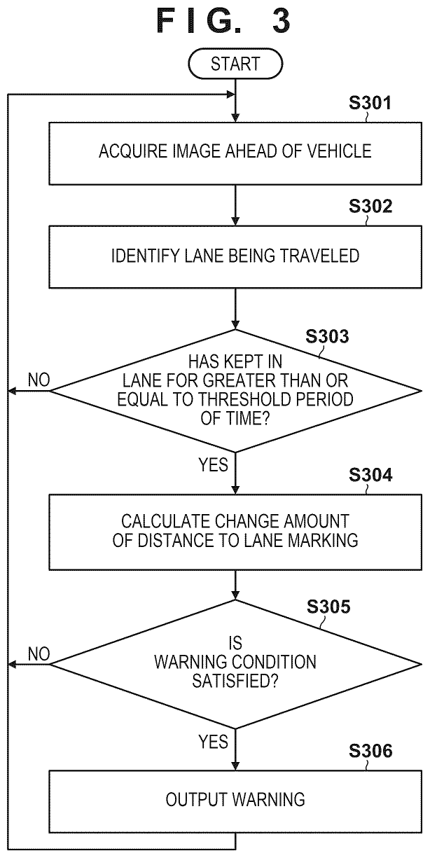

An operation example of the drive recorder 100 will be described with reference to FIG. 3. In some embodiments, the drive recorder 100 may have the function of issuing the lane departure warning. That is, the drive recorder 100 may output the warning to the user when the vehicle V is likely to depart from the travel lane. Each step in the method of FIG. 3 may be performed by the processor 201 executing a program stored in the memory 202. Alternatively, some or all of the steps in the method of FIG. 3 may be performed by a dedicated integrated circuit, such as an application specific integrated circuit (ASIC). The method of FIG. 3 may be started in response to the drive recorder 100 being powered on, or may be started in response to the user instructing the start of the function of issuing the lane departure warning, or may be started in another manner. The method of FIG. 3 is typically performed while the vehicle V is traveling in accordance with manual driving, but may be performed while the vehicle V is traveling in accordance with automated driving.

In S301, the processor 201 acquires an image ahead of the vehicle V generated by the camera 203. The camera 203 repeats capturing an image ahead of the vehicle V, while the method in FIG. 3 is being performed. The processor 201 may store the image ahead of the vehicle V in the memory 202 in order to record the image.

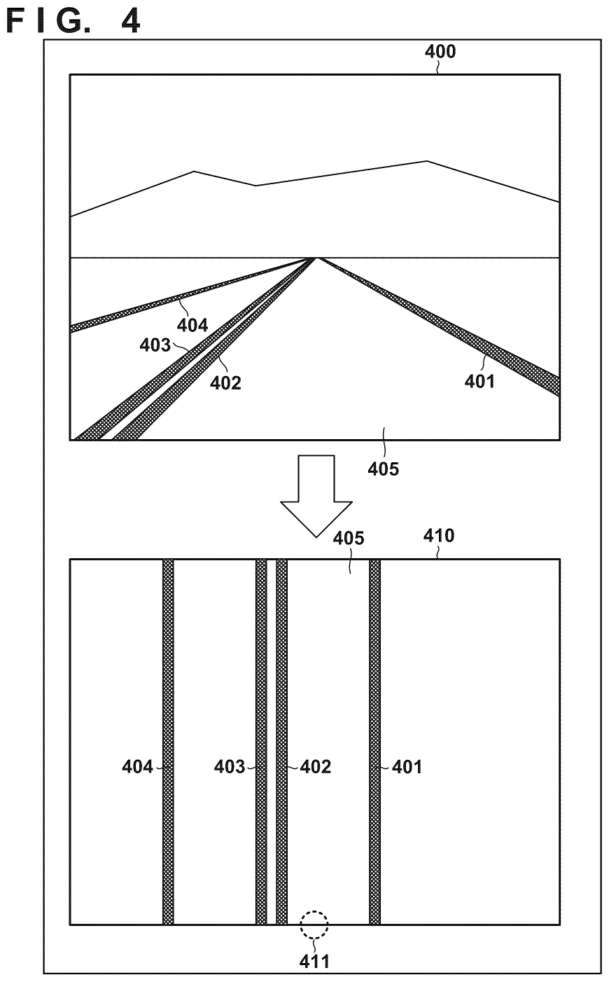

In S302, the processor 201 analyzes the image acquired in S301, and identifies the lane (that is, the travel lane) in which the vehicle V is traveling. An example of an operation for identifying the travel lane will be described with reference to FIG. 4. FIG. 4 is an example of an image 400 ahead of vehicle V generated by the camera 203. The processor 201 performs image recognition on the image 400, and identifies lane markings 401 to 404 of a road on which vehicle V is traveling. The lane marking denotes a line drawn on the road to indicate a structure of the road, and includes, for example, a roadway center line, a lane boundary line, a roadway outside line, and the like. In Japan, the lane marking is a white or yellow line. The white lane marking may also be referred to as a white line. In Japan, a white line is a solid line or a broken line, and a yellow lane marking is a solid line.

Subsequently, the processor 201 identifies, among the lane markings 401 to 404 included in the image 400, a lane marking having an angle defined with the advancing direction of the vehicle V to fall within a predetermined range (for example, within 30 degrees). For example, the processor 201 converts the image 400 into a top view image 410. The top view image 410 is a view of at least a portion in the vicinity of the drive recorder 100 in the road included in the image 400, when viewed from directly above the vehicle V A location 411 at the center on the lower side of the top view image 410 may correspond to the location of the drive recorder 100 on the road. The top view image 410 may be generated using the existing technique. Then, the processor 201 identifies, in the top view image 410, lane markings (in the example of FIG. 4, the lane markings 401 to 404) each having the angle defined with the advancing direction of the vehicle V to fall within a predetermined range (for example, within 30 degrees). The processor 201 may set the longitudinal direction of the top view image 410 as the advancing direction of the vehicle V.

Then, the processor 201 identifies, as a right lane marking, a lane marking (in the example of FIG. 4, the lane marking 401) that is located on the right side of the drive recorder 100, and that is closest to the drive recorder 100 among the lane markings each having the angle defined with the advancing direction of the vehicle V to fall within the predetermined range. In addition, the processor 201 identifies, as a left lane marking, a lane marking (in the example of FIG. 4, the lane marking 402) that is located on the left side of the drive recorder 100, and that is closest to the drive recorder 100 among the lane markings each having the angle defined with the advancing direction of the vehicle V to fall within the predetermined range. In this manner, the right lane marking is a lane marking, which is located on the right side of the drive recorder 100, which has the angle defined with the advancing direction of the vehicle V to fall within the predetermined range, and which does not include any other lane marking between the drive recorder 100 and the right lane marking. The left lane marking is a lane marking, which is located on the left side of the drive recorder 100, which has the angle defined with the advancing direction of the vehicle V to fall within the predetermined range, and which does not include any other lane marking between the drive recorder 100 and the left lane marking.

Then, the drive recorder 100 identifies an area between the right lane marking (the lane marking 401) and the left lane marking (the lane marking 402), as a travel lane 405. In the above-described example, the processor 201 identifies the travel lane 405 by converting the image 400 into the top view image 410. Alternatively, the processor 201 may analyze the image 400 without change, identify a lane marking having the angle defined with the advancing direction of the vehicle V to fall within the predetermined range (for example, within 30 degrees), may identify the right lane marking and the left lane marking, and may identify the travel lane 405.

In a case where it is not possible to identify the right lane marking, but it is possible to identify the left lane marking, the processor 201 may identify an area located on the right of the left lane marking, as the travel lane. In a case where it is not possible to identify the left lane marking, but it is possible to identify the right lane marking, the processor 201 may identify an area located on the left of the right lane marking, as the travel lane. In a case where it is not possible to identify either the left lane marking or the right lane marking, the processor 201 may determine that the vehicle V is not traveling in a lane, and may repeatedly perform S301 and S302 without shifting to S303.

Returning to the description of FIG. 3, in S303, the processor 201 determines whether the period of time while the vehicle V is continuously traveling in the identical lane reaches a threshold period of time. In a case where it is determined that the period of time while the vehicle V is continuously traveling in the identical lane reaches the threshold period of time (“YES” in S303), processor 201 shifts the processing to S304, and in the other case (“NO” in S303), the processor shifts the processing to S301. Advantages of this step will be described later.

In S304, the processor 201 calculates the distance between the drive recorder 100 and the lane marking, and stores the distance in the memory 202 in association with the current time. The lane marking for use in this calculation of the distance will be referred to as a reference lane marking. The reference lane marking may be any of the lane markings (in the example of FIG. 4, the lane markings 401 to 404) identified in S302 and each having the angle defined with the advancing direction of the vehicle V to fall within the predetermined range (for example, within 30 degrees). In particular, the reference lane marking may be a right lane marking or a left lane marking. The lane marking near the drive recorder 100 is recognizable with high accuracy and the accuracy in measuring the distance is also high. Therefore, the lane departure warning can be accurately issued, by using such a lane marking as the reference lane marking. The number of reference lane markings may be one or plural. The distance between the drive recorder 100 and the reference lane marking may be the shortest distance between the location 411 and the reference lane marking (for example, the lane marking 401) in the top view image 410.

In S305, the processor 201 determines whether a warning condition is satisfied. When determining that the warning condition is satisfied (“YES” in S305), the processor 201 shifts the processing to S306, and in the other case (“NO” in S305), the processor shifts the processing to S301. The warning condition denotes a condition that the drive recorder 100 should satisfy in order to issue a warning to the user. For example, the warning condition may include the determination that the vehicle V is likely to depart from the travel lane 405. For example, the processor 201 may determine whether the vehicle V is likely to depart from the travel lane, based on a change amount per unit time in the distance between the drive recorder 100 and the reference lane marking, and may determine that the warning condition is satisfied when determining that the vehicle V is likely to depart.

In S306, the processor 201 outputs a warning to the user. The warning may be issued in such a manner that the user is able to recognize that the vehicle V is likely to depart from the lane. The warning may be output in any manner. For example, the processor 201 may output a warning (for example, a warning sound) from the output device 206 (for example, a speaker) of the drive recorder 100. The processor 201 may request the control device CNT of the vehicle V to issue a warning directed to the user via the communication device 204. Upon receipt of this request, the control device CNT may display a screen including a warning message using the information output device 5, or may reproduce the warning message by sound. The processor 201 may end the warning when a certain period of time elapses, or may end the warning in response to a user's instruction.

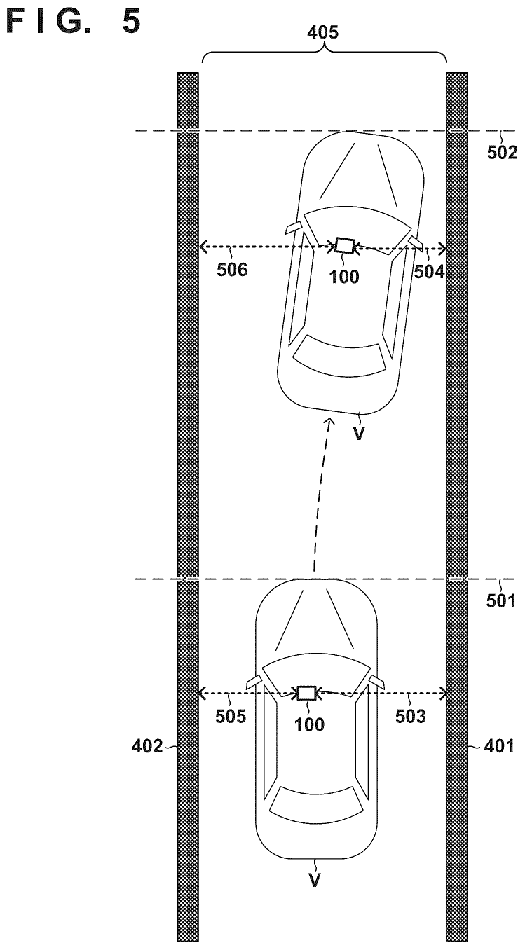

A specific example of the warning condition will be described with reference to FIG. 5. It is assumed that the vehicle V is traveling on the travel lane 405 in which the lane marking 401 is the right lane marking and the lane marking 402 is the left lane marking. It is assumed that the head of the vehicle is located at a location 501 at time T1, and the head of vehicle V is located at a location 502 subsequently at time T2. First, a case where the processor 201 uses only the right lane marking (the lane marking 401) as the reference lane marking will be described. The same reasoning also applies to a case where the processor 201 uses only the left lane marking (the lane marking 402) as the reference lane marking.

At time T1, the processor 201 performs S304 to calculate a distance 503 between the drive recorder 100 and the lane marking 401, and stores the distance in the memory 202 in association with time T1. Subsequently, at time T2, the processor 201 performs S305 again to calculate a distance 504 between the drive recorder 100 and the lane marking 401, and stores the distance in the memory 202 in association with time T2. Then, in S305, the processor 201 calculates a change amount per unit time in the distance between the drive recorder 100 and the lane marking 401. The unit time is a value determined beforehand, and is stored in the memory 202, for example. The unit time may be, for example, 0.5 seconds, one second, five seconds, or the like. In the following description, it is assumed that the time from time T1 to time T2 corresponds to the unit time. Therefore, the processor 201 sets a value obtained by subtracting the distance 503 from the distance 504 as the change amount per unit time in the distance between the drive recorder 100 and the lane marking 401. This change amount becomes a positive value when the vehicle V separates from the lane marking 401, and becomes a negative value when the vehicle V approaches the lane marking 401.

In a case where the change amount is smaller than a predetermined value (for example, −30 cm), the processor 201 may determine that the vehicle V is likely to cross over the right lane marking (the lane marking 401) and depart from the travel lane 405. In a case where the change amount is larger than a predetermined value (for example, 30 cm), the processor 201 may determine that the vehicle V is likely to cross over the left lane marking (the lane marking 402) and depart from the travel lane 405. The processor 201 may determine that the vehicle V is not likely to depart from the travel lane 405, in a case where the change amount falls within a predetermined range (for example, between −30 cm and 30 cm).

The change amount per unit time in the distance between the drive recorder 100 and the reference lane marking is considered to match or substantially match the change amount per unit time in the distance between the vehicle V and the reference lane marking, even though which position of the vehicle V the drive recorder 100 is attached to. Therefore, as described above, it becomes possible to issue the lane departure warning appropriately by using the image generated by the drive recorder 100, based on the change amount per unit time in the distance between the drive recorder 100 and the reference lane marking.

Next, a case where the processor 201 uses both the right lane marking (the lane marking 401) and the left lane marking (the lane marking 402) as the reference lane markings will be described. At time T1, the processor 201 performs S304 to calculate the distance 503 between the drive recorder 100 and the lane marking 401 and a distance 505 between the drive recorder 100 and the lane marking 402, and stores the distances in the memory 202 in association with time T1. Subsequently, at time T2, the processor 201 performs S305 again to calculate the distance 504 between the drive recorder 100 and the lane marking 401 and a distance 506 between the drive recorder 100 and the lane marking 402, and stores the distances in the memory 202 in association with time T2. Then, in S305, the processor 201 calculates a change amount per unit time in the distance between the drive recorder 100 and the lane marking 401 (hereinafter, a right change amount) and a change amount per unit time in the distance between the drive recorder 100 and the lane marking 402 (hereinafter, a left change amount).

In a case where the right change amount is smaller than a predetermined value (for example, −30 cm), the processor 201 may determine that the vehicle V is likely to cross over the right lane marking (the lane marking 401) and depart from the travel lane 405. In a case where the left change amount is smaller than a predetermined value (for example, −30 cm), the processor 201 may determine that the vehicle V is likely to cross over the left lane marking (the lane marking 402) and depart from the travel lane 405. In a case where the right change amount is larger than a predetermined value (for example, −30 cm) and the left change amount is larger than a predetermined value (for example, −30 cm), the processor 201 may determine that the vehicle V is not likely to depart from the travel lane 405.

For example, in a case where the travel lane 405 becomes broader in width, the distance between the drive recorder 100 and the reference lane marking may increase, although the vehicle V is not likely to depart from the travel lane 405. As described above, by using both the right lane marking and the left lane marking as the reference lane markings, it becomes possible to suppress an excessive lane departure warning.

As described above with reference to FIG. 3, in the case where the period of time while the vehicle V is continuously traveling in the identical lane is shorter than the threshold period of time, the processor 201 does not issue a warning based on the change amount per unit time in the distance between the drive recorder 100 and the reference lane marking. Immediately after the vehicle V starts traveling in a different lane, the location of the vehicle V in the travel lane in the vehicle width direction may fluctuate. Therefore, by performing S303, it becomes possible to suppress an excessive lane departure warning. The threshold period of time is a value determined beforehand, and is stored in the memory 202, for example. The threshold period of time may be, for example, 30 seconds, one minute, five minutes, or the like.

The warning condition may be based not only on the change amount per unit time in the distance between the drive recorder 100 and the reference lane marking as described above but also on the fact that the distance between the drive recorder 100 and the reference lane marking falls within a threshold distance. That is, the processor 201 may output a warning, when the distance between the drive recorder 100 and the reference lane marking falls within the threshold distance. The threshold distance is a value determined beforehand, and is stored in the memory 202, for example. The threshold distance may be, for example, 30 cm, 50 cm, or the like. In order to suppress the excessive lane departure warning, the threshold distance may be a value that has been set by assuming that the drive recorder 100 is attached to a position in the vehicle V that is closest to the reference lane marking.

### Summary of Embodiments

### [Item 1]

A drive recorder (100) comprising:
a camera (203) configured to generate an image (400) ahead of a vehicle (V) to which the drive recorder is attached;
an identification unit (201) configured to identify, based on the image, a lane marking (401-404) of a road on which the vehicle is traveling;
a determination unit (201) configured to determine whether the vehicle is likely to depart from a travel lane (405), based on a change amount per unit time in a distance (503-506) between the drive recorder and the lane marking; and
a warning unit (201) configured to output a warning upon determination that the vehicle is likely to depart from the travel lane.

According to this item, the vehicle departure warning can be issued using the image that has been generated by the drive recorder.

### [Item 2]

The drive recorder according to Item 1, wherein in a case where a period of time while the vehicle is continuously traveling in an identical lane is shorter than a threshold period of time, the warning unit ceases to issue a warning based on the change amount per unit time in the distance between the drive recorder and the lane marking.

According to this item, it becomes possible to suppress the excessive vehicle departure warning.

### [Item 3]

The drive recorder according to Item 1 or 2, wherein
the identification unit uses, as the lane marking, at least one of
   a right lane marking (401) located on a right side of the drive recorder, having an angle defined with an advancing direction of the vehicle to be equal to or smaller than a predetermined angle, and including no lane marking between the right lane marking and the drive recorder, and
   a left lane marking (402) located on a left side of the drive recorder, having an angle defined with the advancing direction of the vehicle to be equal to or smaller than the predetermined angle, and including no lane marking between the left lane marking and the drive recorder.

According to this item, the vehicle departure warning can be issued accurately.

### [Item 4]

The drive recorder according to any one of Items 1 to 3, wherein the warning unit further outputs a warning when the distance between the drive recorder and the lane marking falls within a threshold distance.

According to this item, the vehicle departure warning can be issued accurately.

### [Item 5]

A method for controlling a drive recorder (100) including a camera (203) configured to generate an image ahead of a vehicle (V), the method comprising:
identifying (S302), based on the image, a lane marking (401-404) of a road on which the vehicle is traveling;
determining (S305) whether the vehicle is likely to depart from a travel lane (405), based on a change amount per unit time in a distance (503-506) between the drive recorder and the lane marking; and
outputting (S306) a warning upon determination that the vehicle is likely to depart from the travel lane.

According to this item, the vehicle departure warning can be issued using the image that has been generated by the drive recorder.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A drive recorder comprising:
a camera configured to generate an image ahead of a vehicle to which the drive recorder is attached;
an identification unit configured to identify, based on the image, a lane marking of a road on which the vehicle is traveling;
a determination unit configured to determine whether the vehicle is likely to depart from a travel lane, based on a change amount per unit time in a distance between the drive recorder and the lane marking; and
a warning unit configured to output a warning upon determination that the vehicle is likely to depart from the travel lane.

2. The drive recorder according to claim 1, wherein in a case where a period of time while the vehicle is continuously traveling in an identical lane is shorter than a threshold period of time, the warning unit ceases to issue a warning based on the change amount per unit time in the distance between the drive recorder and the lane marking.

3. The drive recorder according to claim 1, wherein
the identification unit uses, as the lane marking, at least one of
a right lane marking located on a right side of the drive recorder, having an angle defined with an advancing direction of the vehicle to be equal to or smaller than a predetermined angle, and including no lane marking between the right lane marking and the drive recorder, and
a left lane marking located on a left side of the drive recorder, having an angle defined with the advancing direction of the vehicle to be equal to or smaller than the predetermined angle, and including no lane marking between the left lane marking and the drive recorder.

4. The drive recorder according to claim 1, wherein the warning unit further outputs a warning when the distance between the drive recorder and the lane marking falls within a threshold distance.

5. A method for controlling a drive recorder including a camera configured to generate an image ahead of a vehicle, the method comprising:
identifying, based on the image, a lane marking of a road on which the vehicle is traveling;
determining whether the vehicle is likely to depart from a travel lane, based on a change amount per unit time in a distance between the drive recorder and the lane marking; and
outputting a warning upon determination that the vehicle is likely to depart from the travel lane.
